(19) United States
(12) Patent Application Publication
(10) Pub. No.: US 2025/0211464 A1
(43) Pub. Date: Jun. 26, 2025

(54) TRAILER NETWORK SYSTEM FOR DATA COMMUNICATION IN A TRAILER VEHICLE, TRAILER VEHICLE HAVING SAME, AND METHOD FOR SAME

(71) Applicant: ZF CV Systems Global GmbH, Bern (CH)

(72) Inventors: Udo Ronnenberg, Wedemark (DE); Nils Pfullmann, Hannover (DE); Fabian Ickerott, Muenster Albachten (DE); Jan-Christoph von der Beeke, Algermissen (DE); Axel Stender, Hameln (DE)

(21) Appl. No.: 19/076,671

(22) Filed: Mar. 11, 2025

Related U.S. Application Data
(63) Continuation of application No. PCT/EP2023/073138, filed on Aug. 23, 2023.

(30) Foreign Application Priority Data
Sep. 23, 2022 (DE) 10 2022 124 559.4

(51) Int. Cl. H04L 12/40

(52) U.S. Cl. CPC H04L 12/40182; H04L 12/40189; H04L 2012/40273

(57) ABSTRACT

A trailer network system is for data communication in a trailer vehicle. The trailer network system includes at least two main control units and at least one auxiliary control unit. The trailer network system further includes a main data bus having a plurality of main data bus interfaces, to which only the main control units are connected, and an auxiliary data bus having a plurality of auxiliary data bus interfaces, to which the main control units and the auxiliary control unit are connected. The main control units each serve for executing safety-relevant functions of the trailer vehicle, and the auxiliary control unit serves for executing non-safety-relevant functions. A method is for operating a trailer network system.

### CROSS-REFERENCE TO RELATED APPLICATIONS

This application is a continuation application of international patent application PCT/EP2023/073138, filed Aug. 23, 2023, designating the United States and claiming priority from German application 10 2022 124 559.4, filed Sep. 23, 2022, and the entire content of both applications is incorporated herein by reference.

### TECHNICAL FIELD

The disclosure relates to the field of vehicles and, in particular, the field of utility vehicles. Such utility vehicles include towing vehicles, such as trucks or semitrailer trucks, and trailer vehicles, for example draw-bar trailers or semitrailers. In particular, the disclosure relates to trailer vehicles.

### BACKGROUND

The vehicles considered here include a multiplicity of control units, which are also known as electronic control units or ECUs for short. The control units are used to control individual functions of the vehicle. By way of example, actuators of the vehicle are preferably activated by the control units or sensors of the vehicle are preferably read by the control units. Examples of control units for vehicles are brake control units (EBS or TEBS for short) for activating various brake functionalities, for example for activating friction brakes of the vehicle, and air suspension control units for activating the air suspension. Control units of modern vehicles are connected to one another via a vehicle network for data communication, in particular a data bus, in order to exchange data with one another.

In this regard, a control unit of an air suspension system may be used to determine a mass of the vehicle. To this end, the prevailing pressure in the air springs is measured by a sensor and transmitted to the control unit of the air suspension system. The control unit may determine the mass from the prevailing pressure and provide the determined mass to a brake control unit, for example, wherein the brake control unit may then take these masses into account for the activation of the actuators.

Owing to the increasing number of such control units, and therefore the increasing interaction between the control units, the demands on the vehicle network for data exchange are increasing, in particular with regard to the data integrity of a vehicle network system which includes the control units and the vehicle network itself. The demands for data integrity are becoming particularly relevant due to increasingly automated driving functions, which enable partially or fully autonomous operation of the vehicle and are also realized using the control units. Control units for realizing the automated driving functions must be able to access sensors and actuators of the vehicle without error, while manipulation of such access may lead to dangerous driving situations or accidents. To ensure data integrity, control units which may execute safety-critical functions are therefore frequently not connected to general data buses of the vehicle. Instead, secure connections are provided for such control units so that such control units exchange control commands, in particular safety-critical control commands, using the secure connections.

Various measures for meeting the demands for data integrity are already known. By way of example, a trailer network system according to the prior art is configured such that a safety-critical control unit, such as the brake control unit, receives safety-critical commands, for example for activating the friction brakes, from the towing vehicle via a standardized interface with a protocol according to ISO 11992-2. Modern trailer vehicles moreover have a further interface, which exchanges data with the towing vehicle using a protocol according to ISO 11992-3. Communication with further components of the trailer vehicle, which are connected, for example, via a bus system, may take place via the further interface.

However, in addition, or even alternatively, to previous interfaces, efforts are increasingly being made to provide an interface via which all commands, including safety-critical commands, may be transmitted from the towing vehicle to the trailer vehicle and via which data may be exchanged between further control units or components of the trailer vehicle and the towing vehicle. All of the data traffic between the towing vehicle and trailer vehicle is then to be realized via such an interface so that consequently all control units of the trailer vehicle may be connected to this interface, for example via a bus. In particular, control units which enable wireless remote access to the trailer network system, for example, then pose a risk to safety-relevant control units, namely control units which execute safety-relevant functions, for example the brake control unit.

### SUMMARY

It is an object of the present disclosure to address the problems of the prior art. In particular, the aim is to reduce the risk of access by components of the vehicle to safety-critical systems leading to dangerous driving interventions. In any case, the aim is to find an alternative to what is known from the prior art.

A trailer network system according to the disclosure serves for data communication in a trailer vehicle. The trailer network system includes at least two main control units. The main control units are each configured to execute safety-relevant functions of the trailer vehicle. In addition, the trailer network system includes at least one auxiliary control unit. The auxiliary control unit serves for executing non-safety-relevant functions, that is, functions which are not safety-relevant.

In addition, the trailer network system includes a main data bus. The main data bus includes a plurality of main data bus interfaces. The main control units are each connected to a main data bus interface of the plurality of main data bus interfaces. The main control units are therefore connected to one another via the main data bus in order to exchange data. The auxiliary control unit is unconnected, that is, not connected, to the main data bus. If there are a plurality of auxiliary control units, all of the auxiliary control units are unconnected to the main data bus.

In addition, the trailer network system includes an auxiliary data bus with a plurality of auxiliary data bus interfaces. An auxiliary data bus interface of the plurality of auxiliary data bus interfaces is connected to one of the main control units. A further auxiliary data bus interface is connected to a further one of the main control units. Another further auxiliary data bus interface of the plurality of auxiliary data bus interfaces is connected to the auxiliary control unit. If there are a plurality of main control units and/or a plurality of auxiliary control units, all main and auxiliary control units are therefore each connected to the auxiliary bus. The auxiliary data bus therefore serves for the data exchange between all main and auxiliary control units of the trailer network system.

According to the disclosure, the main control unit(s) is/are therefore connected to one another by two data buses, namely by the main data bus and the auxiliary data bus. An idea of the disclosure is that the main data bus connects only the main control units, but not the auxiliary control units. Therefore, the main data bus does not provide any interfaces for the connection of auxiliary control units of the trailer vehicle. An auxiliary data bus is provided for the connection of auxiliary control units. Therefore, control units which execute non-safety relevant functions and may present a risk to control units which execute safety-relevant functions can only be connected via the auxiliary data bus.

Secure communication between main control units is therefore possible via the main data bus, so that safety-critical commands, which are received from a towing vehicle or from a further main control unit by one of the main control units, for example, may be securely transmitted to the main control unit. Auxiliary control units of the trailer vehicle may not access the main data bus since this cannot be accessed by the auxiliary control units. This configuration of the trailer network system enables secure communication for the control units which execute safety-relevant functions. Furthermore, the configuration also enables the main control units to communicate via the auxiliary data bus in the event of a failure of the main data bus. A partially redundant bus connection is therefore present so that the disadvantage of the additional expense involved in increasing the data integrity is offset by simultaneously increasing the failure-safety. Although the main control units are less protected against access by the auxiliary control units in the event of failure of the main data bus, the relatively small likelihood of such access in this type of situation is accepted so as to still ensure communication between the main control units despite the failure of the main data bus.

According to a first embodiment, the main control units each correspond to a control unit which is configured to influence a driving function of the trailer vehicle. In particular, each of the main control units is, in each case, configured to activate an actuator of the trailer vehicle. According to this embodiment, the auxiliary control unit is a control unit which is configured to leave the driving function of the trailer vehicle uninfluenced. In particular, the auxiliary control unit is configured to execute an actuator-free function. The main control units therefore each serve to control all functions which relate to the driving of the trailer vehicle and have a direct influence on the driving or movement thereof. The auxiliary control unit therefore corresponds to a control unit which has no direct influence on the driving or movement of the trailer vehicle.

Auxiliary control units which therefore have no direct influence on the driving function remain unconnected to the main data bus and can therefore have no influence on main control units which exchange safety-relevant data via the main data bus and which may, in particular, have an influence on driving functions of the trailer vehicle as a result of this exchange.

According to a further embodiment, each of the main control units is, in each case, configured to activate at least one actuator for actuating a service brake, an actuator for actuating a parking brake, an actuator for lifting and/or lowering a lifting axle, an actuator for lifting and/or lowering a trailer support foot, an actuator for activating a trailer-vehicle level control or an actuator, in particular an electric motor, for driving or braking a wheel or an axle of the trailer vehicle. According to this embodiment, the auxiliary control unit is configured to execute a function which differs from the activation of the actuators mentioned according to this embodiment which can be activated by the main control unit.

An exhaustive list of actuators is therefore specified, which can each be activated via a plurality of main control units. By way of example, a first main control unit is configured as a control unit for activating a service brake and a further main control unit is configured as a control unit for lifting and/or lowering a lifting axle. Another further main control unit is configured as a control unit for driving or braking a wheel or an axle. Furthermore, auxiliary control units are configured to execute a function which differs from the exhaustive list for the actuators.

The actuators are explicitly actuators whereof an actuation represents a safety-relevant function and is therefore executed by a main control unit. Such actuators are therefore not activated by auxiliary control units, but exclusively by main control units. Safety-critical commands to a main control unit which are sent on the auxiliary bus from an auxiliary control unit which is, in turn, not connected to the main data bus may be ignored. The data integrity for the communication of all control units which have an influence on these safety-relevant actuators may be safeguarded against access from control units which are not connected to the main data bus.

According to a further embodiment, at least one of the main control units or all main control units include(s) a data interface unit. The data interface unit is connected to a main data bus interface and an auxiliary data bus interface. The data interface unit is configured to differentiate between disrupted and undisrupted data traffic on the main data bus, that is, to detect whether the data traffic is disrupted or undisrupted. If the data interface unit detects undisrupted data traffic on the main data bus, the data interface unit is configured to ignore safety-critical data on the auxiliary data bus. Safety-critical data are preferably predefined data or data packets which include a command for activating the brakes of the trailer vehicle, for example. The data interface unit is preferably also configured not to ignore, that is, to process, safety-critical data on the auxiliary data bus in the event that disrupted data traffic is detected on the main data bus.

As a result of the data interface unit, the main control unit is therefore configured to ignore safety-critical data, for example data which correspond to safety-critical data and are sent from an auxiliary control unit connected to the auxiliary data bus, so long as operation using the main data bus, namely undisrupted data traffic using a further main control unit, is possible. Access to the main control unit by an auxiliary control unit which is connected to the auxiliary data bus is therefore prevented entirely in the case of an undisrupted main data bus. Nevertheless, redundant communication between the main control units is possible in the event of a failure of the main data bus. In particular, non-critical data may also be sent from auxiliary control units to the brake control unit via the auxiliary data bus and processed by the brake control unit.

According to a further embodiment, the trailer network system includes one or more auxiliary control units, which are configured as a telematics system, wireless interface module, operating unit or display unit. The trailer network system therefore includes one or more of a telematics system, a wireless interface module, an operating unit and a display unit. If, for example, an auxiliary control unit is connected to the auxiliary data bus as a display unit via an auxiliary data bus interface, parameters from other auxiliary control units may preferably be displayed by the display unit. Such parameters may also include parameters which are provided on the auxiliary data bus by a main control unit. The auxiliary control units may therefore communicate with one another and with the towing vehicle, for example via a main control unit configured as a trailer interface module. The processing of data of a main control unit configured as a trailer brake control unit via the auxiliary control units is likewise possible, whereas safety-critical data addressed to the trailer brake control unit from one of the auxiliary control units, in particular via the data interface unit, are not processed in the trailer brake control unit.

According to a further embodiment, the trailer network system includes a plurality of main control units, wherein one of the main control units corresponds to a trailer brake control unit and is configured to activate friction brakes of the trailer vehicle. A further main control unit corresponds to a control unit for activating an electric drive of the trailer vehicle. Safety-critical data therefore include braking requests for activation of the friction brakes, which are addressed to the trailer brake control unit from a main control unit configured as a trailer interface module. Further safety-critical data are acceleration requests for activation of an electric drive controlled by the brake control unit or braking requests for activation of a regenerative mode of the electric drive. Braking requests can therefore be transmitted to the trailer brake control unit via the main data bus in order to activate the friction brakes. However, braking requests via the auxiliary data bus are preferably ignored so long as the trailer brake control unit detects undisrupted data traffic on the main data bus.

According to a further embodiment, the trailer network system includes a plurality of main control units, wherein a trailer brake control unit is formed by at least two of the main control units. At least one, a plurality of or all the main control units forming the trailer brake control unit is/are configured to activate friction brakes of the trailer vehicle. Safety-critical data include braking requests for activation of the friction brakes, which are addressed to at least one of the main control units forming the trailer brake control unit. Safe activation of a trailer brake control unit formed by a plurality of main control units is therefore possible.

According to a further embodiment, the trailer network system includes a plurality of main control units, wherein one of the main control units is configured as a trailer interface module and has a first towing-vehicle data interface in order to exchange data with a towing vehicle. The first towing-vehicle data interface is an Ethernet data interface and, particularly preferably, a Gigabit Ethernet data interface. Via such Ethernet connections, which can be provided by the first towing-vehicle data interface, rapid data exchange between the towing vehicle and the trailer vehicle is possible, for example, in order to also exchange large quantities of data from either cameras connected directly to the auxiliary data bus or the trailer interface module in addition to safety-critical data for safety-critical systems, such as braking requests.

According to a further embodiment, the main control unit configured as a trailer interface module includes a second towing-vehicle data interface. The second towing-vehicle data interface likewise serves for the exchange of data with the towing vehicle. The second towing-vehicle data interface is a standardized data interface according to ISO 11992-3. As a result of providing this second towing-vehicle data interface, communication between the towing vehicle and trailer vehicle is possible in the event that the towing vehicle does not have an Ethernet data interface. Backward compatibility of the trailer network system with known towing vehicles is therefore maintained.

According to a further embodiment, the trailer network system includes a main control unit configured as a brake control unit, which has a third towing-vehicle data interface. The third towing-vehicle data interface is configured to exchange data with the towing vehicle. The third towing-vehicle data interface is a standardized interface, which is configured according to standard ISO 11992-2. Therefore, the trailer network system will likewise be compatible in the future with towing vehicles which do not have an Ethernet data interface but which at least have an ISO 11992-2 interface, in order to activate braking of the trailer vehicle.

In addition, the disclosure includes a trailer vehicle having a trailer network system according to one of the above-mentioned embodiments. Furthermore, the disclosure includes a towing vehicle/trailer combination having a trailer vehicle according to the disclosure and a towing vehicle.

Moreover, the disclosure includes a method for operating a trailer network system according to one of the embodiments, a trailer vehicle according to the disclosure or a towing vehicle/trailer combination according to the disclosure.

According to an embodiment of the method, at least one or each of the main control units detects data packets addressed thereto and containing safety-critical data on the auxiliary data bus. The main control unit determines whether the main data bus is disrupted or undisrupted. The detected data packet is processed if the main data bus is disrupted and discarded if the main data bus is undisrupted. According to a preferred development, in the event that safety-critical data is received on the auxiliary data bus while the main data bus is undisrupted, an error message is output by the main control unit.

Auxiliary control units which are connected to the auxiliary data bus and send safety-critical data to a main control unit therefore remain non-critical for operation of the trailer vehicle so long as the main data bus is undisrupted. The likelihood of the brake control unit being accessed by an auxiliary control unit is therefore reduced and limited to cases in which the main data bus is disrupted. The likelihood of a main control unit being accessed by an auxiliary control unit is therefore significantly reduced. The output of an error message serves to make any access visible. Measures may therefore be initiated by a user in order to oppose further access.

According to an embodiment of the method, the main control unit or each of the main control units detect(s) data packets addressed thereto and containing non-safety-critical data on the auxiliary data bus. A thus-detected data packet containing non-safety-critical data is processed by the main control unit. Such non-safety-critical data include, for example, the retrieval of certain parameters from the brake control unit—for example a braking state—via an auxiliary control for display, transmission or further processing.

According to a further embodiment of the method, the method includes receiving safety-critical data for a main control unit configured as a trailer brake control unit from the towing vehicle via the first towing-vehicle data interface or the second towing-vehicle data interface. A main control unit configured as a trailer interface module, which is used for this purpose, moreover determines or detects whether the main data bus is disrupted or undisrupted, that is, whether the data traffic is disrupted or whether undisrupted data traffic is possible. Furthermore, a data packet addressed to the trailer brake control unit and containing the received safety-critical data is sent on the main data bus by the trailer interface module if the main data bus is undisrupted. If the main data bus is disrupted, the data packet is sent to the trailer brake control unit on the auxiliary data bus.

According to a further embodiment of the method, the method includes receiving data for an auxiliary control unit from the towing vehicle via the trailer interface module via the first towing-vehicle data interface or the second towing-vehicle data interface. In addition, the method according to this embodiment includes sending a data packet addressed to the auxiliary control unit and containing the data on the auxiliary data bus, irrespective of whether the main data bus is disrupted or undisrupted. Data which are intended for the auxiliary control units are therefore always sent on the auxiliary data bus.

### BRIEF DESCRIPTION OF DRAWINGS

The invention will now be described with reference to the drawings wherein:

FIG. 1 shows an embodiment of a trailer network system; and,

FIG. 2 shows steps of the method according to an embodiment.

### DETAILED DESCRIPTION

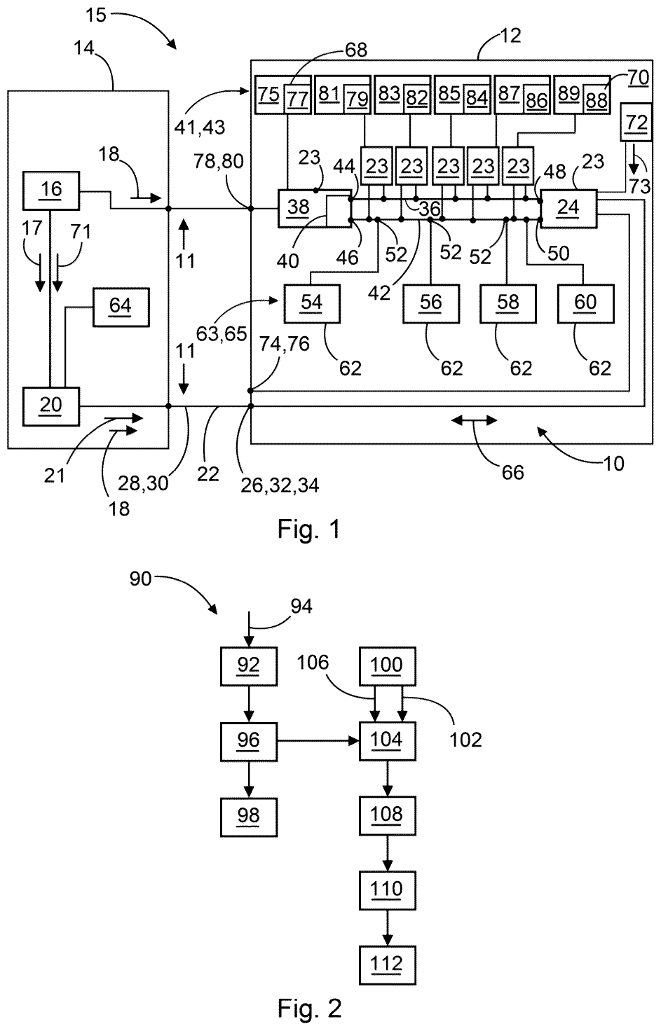

FIG. 1 shows a trailer network system 10 for data communication in a trailer vehicle 12. The trailer vehicle 12 is connected to a towing vehicle 14 via data lines 11 in order to exchange data between the trailer vehicle 12 and towing vehicle 14. The trailer vehicle 12 and towing vehicle 14 form a towing vehicle/trailer combination 15. The towing vehicle 14 has a towing-vehicle brake control unit 16, which generates a braking request 17 for friction brakes of the towing vehicle 14, for example, subject to a driver input. In addition, subject to this braking request 17 for the towing vehicle 14, a braking request 17 for a trailer vehicle 12 is also generated in the towing-vehicle brake control unit 16. Braking requests 17 for the trailer vehicle 12 are transmitted to the trailer vehicle 12 as data, wherein such data are predefined as safety-critical data 18.

In order to send the safety-critical data 18 of a braking request 17 to the trailer vehicle 12, the towing-vehicle brake control unit 16 generates the braking request 17 and transmits it to a towing-vehicle interface module 20. The towing-vehicle interface module 20 generates a data packet 21 containing the safety-critical data 18 and transmits it to the trailer network system 10 via a first data connection 22. To receive the data packet 21, the trailer network system 10 includes a trailer interface module 24 configured as a main control unit 23, which is connected to the first data connection 22 via a first towing-vehicle data interface 26. The first data connection 22 is preferably an Ethernet data connection 28 and, in this case, a Gigabit Ethernet data connection 30. The first towing-vehicle data interface 26 is therefore an Ethernet data interface 32 and, in this case, a Gigabit Ethernet data interface 34.

The safety-critical data 18 are transmitted from the trailer interface module 24 to a further main control unit 23, which is configured as a trailer brake control unit 38 of the trailer network system 10, via a main data bus 36. The trailer interface module 24 corresponds to a Gateway module. This serves the purpose of facilitating connections between different network sections. Different communication protocols may be used in the network sections. The Gateway module is configured to carry out protocol conversion so that information in the format of one communication protocol may be converted into information of the other communication protocol, and vice versa. The Gateway module may be accommodated in a separate housing, in the manner of an electronic control unit, or it may, alternatively, also be part of a main control unit 23. A data interface unit 40, which is connected to the main data bus 36 and an auxiliary data bus 42, is provided in the trailer brake control unit 38 for data reception purposes. To this end, the data interface unit 40 includes a main data bus interface 44 and an auxiliary data bus interface 46. On the other hand, the trailer interface module 24 has a main data bus interface 48 and an auxiliary data bus interface 50. In the manner of the trailer brake control unit 38 configured as the main control unit 23, which is configured to activate an actuator 77 corresponding, for example, to a friction brake 68 of a service brake 75, further main control units 23 are connected to the main data bus 36 and the auxiliary data bus 42 via the respective interfaces The further main control units 23 are each configured to activate an actuator 79 for actuating a parking brake 81, an actuator 82 for lifting and/or lowering a lifting axle 83, an actuator 84 for lifting and/or lowering a trailer support foot 85, an actuator 86 for activating a trailer-vehicle level control 87 and an actuator 88, namely an electric drive 70, for driving a braking a wheel 89. Each of the actuators 77, 79, 84, 86, 88 serves, in each case, for executing one of a plurality of safety-relevant functions 41, which influence the driving functions 43 of the trailer vehicle 12.

The main data bus 36 differs from the auxiliary data bus 42 in that the main data bus 36 includes main data bus interfaces 44, 48, which are each connected to one of the main control units 23, wherein, in addition to the auxiliary data bus interfaces 46, 50 already mentioned, which are connected to the trailer interface module 24 configured as the main control unit 23 and to the trailer brake control unit 38 configured as the main control unit 23, the auxiliary data bus 42 has further auxiliary data bus interfaces 52. A telematics system 54, a wireless interface module 56, an operating unit 58 and a display unit 60 are connected to the further auxiliary data bus interfaces 52. The telematics system 54, the wireless interface module 56, the operating unit 58 and the display unit 60 may also each be referred to as auxiliary control units 62. The auxiliary control units 62 therefore serve for executing actuator-free functions 63, which correspond to non-safety-relevant functions 65.

The auxiliary control units 62 may likewise exchange data with further modules 64 of the towing vehicle 14 via the trailer interface module 24 and the first data connection 22 and also the towing-vehicle interface module 20. The further modules 64 of the towing vehicle 14 and the auxiliary control units 62 exchange data which are referred to as non-critical data 66. According to the disclosure, the non-critical data 66 are exchanged via the auxiliary data bus 42. On the other hand, the safety-critical data 18 are sent to the main control unit 23 configured as the trailer brake control unit 38 via the main data bus 36, at least so long as the main data bus 36 is undisrupted. Friction brakes 68 or an electric drive 70, for example, are activated as a result of these safety-critical data 18, wherein the activation of the electric drive may also take place via the trailer brake control unit 38. Alternatively, as illustrated, the activation of the drive 70 takes place via a further separate main control unit 23. By way of example, to activate the electric drive from the towing vehicle, activating signals 71 for the electric drive are sent from the towing-vehicle brake control unit 16 to the trailer brake control unit 38 as safety-critical data 18.

In addition, a reversing camera 72 is connected to the trailer vehicle 12, wherein the video data 73 thereof may also be transmitted to the towing vehicle 14 via the trailer interface module 24. Moreover, for backward compatibility, the trailer interface module 24 includes a second towing-vehicle data interface 74, which corresponds to an interface 76 according to ISO 11992-3. The trailer brake control unit 38 is moreover configured with a third towing-vehicle data interface 78, which is an interface 80 according to ISO 11992-2, in order to likewise be backward-compatible with the towing vehicle 14. Safety-critical data 18 are therefore also sent directly from the towing-vehicle control unit 16 of the towing vehicle 14 to the trailer brake control unit 38 via the third towing-vehicle data interface 78.

FIG. 2 shows the steps of a method 90 according to one embodiment. In a step 92, a data packet 94 is received by a trailer interface module 24. In step 96, the trailer interface module 24 determines whether the data packet 94 includes safety-critical data 18 or non-critical data 66. If the data of the data packet 94 are non-critical data 66, they are sent on an auxiliary data bus 42 in step 98 if they are intended for an auxiliary control unit 62. If the data are safety-critical data 18 and it has been detected in a previous step 100 that the main data bus 36 is undisrupted 102, the safety-critical data 18 are sent to the trailer brake control unit 38 via the main data bus 36 in a step 104. If, on the other hand, it has been detected in step 100 that the main data bus 36 is disrupted 106, the safety-critical data 18 are sent to the trailer brake control unit 38 via the auxiliary data bus 42 in step 104. In this case, if the trailer brake control unit 38 detects safety-critical data 18 on the auxiliary data bus 42 in step 108, the trailer brake control unit 38 determines, via its data interface unit 40 in step 110, whether the main data bus 36 is disrupted 106 or undisrupted 102. In step 112, the data packet 94 is then processed if the main data bus 36 is disrupted 106 and discarded if the main data bus 36 is undisrupted 102.

It is understood that the foregoing description is that of the preferred embodiments of the invention and that various changes and modifications may be made thereto without departing from the spirit and scope of the invention as defined in the appended claims.

### LIST OF REFERENCE SIGNS (PART OF THE DESCRIPTION)

10 Trailer network system
11 Data lines
12 Trailer vehicle
14 Towing vehicle
15 Towing vehicle/trailer combination
16 Towing-vehicle brake control unit
17 Braking requests
18 Safety-critical data
20 Towing-vehicle interface module
21 Data packet
22 First data connection
23 Main control unit
24 Trailer interface module
26 First towing-vehicle data interface
28 Ethernet data connection
30 Gigabit Ethernet data connection
32 Ethernet data interface
34 Gigabit Ethernet data connection
36 Main data bus
38 Trailer brake control unit
40 Data interface unit
41 Safety-relevant functions
42 Auxiliary data bus
43 Driving functions
44 First main data bus interface
46 Auxiliary data bus interface
48 Second main data bus interface
50 Auxiliary data bus interface
52 Auxiliary data bus interface
54 Telematics system
56 Wireless interface module
58 Operating unit
60 Display unit
62 Auxiliary control units
63 Actuator-free functions
64 Further modules
65 Non-safety-relevant functions
66 Non-critical data
68 Friction brakes
70 Electric drive
71 Activating signals
72 Reversing camera
73 Video data
74 Second towing-vehicle data interface
75 Service brake
76 Interface according to ISO 11992-3
77 Actuator
78 Third towing-vehicle data interface
79 Actuator
80 Interface according to ISO 11992-2
81 Parking brake
82 Actuator
83 Lifting axle
84 Actuator
85 Trailer support foot
86 Actuator
87 Trailer-vehicle level control
88 Actuator
89 Wheel
90 Method
92 Step of the method
94 Data packet
96 Step of the method
98 Step of the method
100 Step of the method
102 Undisrupted data bus
104 Step of the method
106 Disrupted data bus
108 Step of the method
110 Step of the method
112 Step of the method cm 1. A trailer network system for data communication in a trailer vehicle, the trailer network system comprising:
at least two main control units for executing safety-relevant functions of the trailer vehicle;
at least one auxiliary control unit for executing non-safety-relevant functions of the trailer vehicle;
a main data bus having a plurality of main data bus interfaces, wherein each of said at least two main control units is connected to a main data bus interface of said plurality of main data bus interfaces and said auxiliary control unit is unconnected to the main data bus; and,
an auxiliary data bus having a plurality of auxiliary data bus interfaces, wherein each of said at least two main control units is connected to one of said plurality of auxiliary data bus interfaces and said auxiliary control unit is connected to a further auxiliary data bus interface of said plurality of auxiliary data bus interfaces.

2. The trailer network system of claim 1, wherein:
each of said at least two main control units corresponds, in each case, to a control unit configured to influence a driving function of the trailer vehicle; and,
said auxiliary control unit corresponds to a further control unit configured to leave the driving function of the trailer vehicle uninfluenced.

3. The trailer network system of claim 2, wherein at least one of:
the control unit configured to influence a driving function of the trailer vehicle is configured to activate at least one actuator of the trailer vehicle; and,
the further control unit is configured to execute an actuator-free function.

4. The trailer network system of claim 1, wherein each of said at least two main control units is configured to activate at least one actuator of the trailer vehicle including:
an actuator for actuating a service brake;
an actuator for actuating a parking brake;
an actuator for at least one of lifting and lowering a lifting axle;
an actuator for at least one of lifting and lowering a trailer support foot;
an actuator for activating a trailer-vehicle level control;
an actuator for driving or braking a wheel; and,
said auxiliary control unit is configured to execute a function which differs from an activation of said at least one actuator.

5. The trailer network system of claim 1, wherein at least one of said at least two main control units includes a data interface unit configured to differentiate between disrupted data traffic and undisrupted data traffic on said main data bus and, in a case of undisrupted data traffic, to ignore predefined safety-critical data on said auxiliary data bus which are addressed to said at least one of said at least two main control units.

6. The trailer network system of claim 1, wherein said at least one auxiliary control unit corresponds to one of:
a telematics system;
a wireless interface module;
an operating unit; and,
a display unit.

7. The trailer network system of claim 1, wherein said at least two main control units is a plurality of main control units, wherein:
one of said plurality of main control units corresponds to a trailer brake control unit and is configured to activate friction brakes of the trailer vehicle, and,
a further one of said plurality of main control units is a control unit for activating an electric drive of the trailer vehicle, wherein safety-critical data include braking requests for activation of friction brakes and activating signals for activation of the electric drive, which are addressed to one of said plurality of main control units; or,
a trailer brake control unit is formed by at least two of said plurality of main control units, wherein at least one of said plurality of main control units forming said trailer brake control unit is configured to activate the friction brakes of the trailer vehicle, wherein safety-critical data include braking requests for activation of the friction brakes, which are addressed to at least one of said at least two main control units forming said trailer brake control unit.

8. The trailer network system of claim 1, wherein:
said at least two main control units is a plurality of main control units;
one of said plurality of main control units is a trailer interface module having a first towing-vehicle data interface, wherein at least one of:
said first towing-vehicle data interface is an Ethernet data interface; and,
said trailer interface module has a second towing-vehicle data interface, wherein the second towing-vehicle data interface is an interface according to standard ISO 11992-3.

9. The trailer network system of claim 8, wherein said first towing-vehicle data interface is a Gigabit Ethernet data interface.

10. The trailer network system of claim 1, wherein one of said at least two main control units is a trailer brake control unit having a third towing-vehicle data interface; and, said third towing-vehicle data interface is an interface according to standard ISO 11992-2.

11. A trailer vehicle comprising the trailer network system of claim 1.

12. A towing vehicle/trailer combination comprising the trailer vehicle of claim 11; and, a towing vehicle.

13. A method for operating a trailer network system for data communication in a trailer vehicle, the trailer network system including at least two main control units for executing safety-relevant functions of the trailer vehicle, at least one auxiliary control unit for executing non-safety-relevant functions of the trailer vehicle, a main data bus having a plurality of main data bus interfaces, wherein each of the at least two main control units is connected to a main data bus interface of the plurality of main data bus interfaces and the auxiliary control unit is unconnected to the main data bus, the trailer network system further including an auxiliary data bus having a plurality of auxiliary data bus interfaces, wherein each of the at least two main control units is connected to an auxiliary data bus interface of the plurality of auxiliary data bus interfaces and the auxiliary control unit is connected to a further auxiliary data bus interface of the plurality of auxiliary data bus interfaces, the method comprising:
detecting a data packet, which is addressed to one of the at least two main control units and contains safety-critical data, on the auxiliary data bus via the one of the at least two main control units;
determining whether the main data bus is disrupted or undisrupted;
processing the data packet if the main data bus is disrupted; and,
discarding the data packet if the main data bus is undisrupted.

14. The method of claim 13 further comprising:
detecting a further data packet, which is addressed to one of the at least two main control units and contains non-safety-critical data, on the auxiliary data bus via the one of the at least two main control units; and,
processing the further data packet.

15. The method of claim 13, wherein one of the at least two main control units is a trailer brake control unit and one of the at least two main control units is a trailer interface module, the method further comprising:
receiving safety-critical data for the trailer brake control unit via a first towing-vehicle data interface or a second towing-vehicle data interface via the trailer interface module;
determining whether the main data bus is disrupted or undisrupted via the trailer interface module; and,
sending the data packet addressed to the trailer brake control unit and containing the safety-critical data on the main data bus if the main data bus is undisrupted or, if the main data bus is disrupted, sending the data packet on the auxiliary data bus.

16. The method of claim 13, wherein one of the at least two main control units is a trailer interface module, the method further comprising:
receiving data for the auxiliary control unit from a towing vehicle via a trailer interface module, via a first towing-vehicle data interface or a second towing-vehicle data interface; and,
sending the data packet addressed to the auxiliary control unit and containing the data on the auxiliary data bus, irrespective of whether the main data bus is disrupted or undisrupted.
